(19) United States
(12) Patent Application Publication
(10) Pub. No.: US 2004/0135426 A1
(43) Pub. Date: Jul. 15, 2004

(54) Hydraulic braking apparatus

(75) Inventors: Kazutoshi Yogo, Aichi-gun (JP); Hiroyuki Shinkai, Obu-city (JP)

Correspondence Address: POSZ & BETHARDS, PLC, 11250 ROGER BACON DRIVE, SUITE 10, RESTON, VA, 20190, US

(73) Assignee: ADVICS CO., LTD

(21) Appl. No.: 10/751,498

(22) Filed: Jan. 6, 2004

(30) Foreign Application Priority Data
Jan. 8, 2003 (JP) 2003-002087

(51) Int. Cl. B60T 13/18

(52) U.S. Cl. 303/11; 303/116.1; 417/44.2

(57) ABSTRACT

A switching reservoir which reserves brake fluid for reducing a pressure to a wheel cylinder is connected to a pressure decrease control valve and an intake port of a pump through a reservoir port, and connected to a M/C through a connection port. There are a ball valve and a rod below the ball valve inside the connection port. The rod moves up and down the ball valve integrally with a piston of the reservoir chamber. When an amount of the brake fluid in the reservoir chamber becomes less than a predetermined amount, the rod moves upward to cause the ball valve separates from a valve seat and is changed to be in an open sate, allowing the brake fluid to flow in from the M/C. Accordingly, the pump is always capable of sucking up the fluid, thereby preventing sharp increase of the rotational speed of the motor due to a sharp decrease in the pump load caused by an empty reservoir chamber and enabling driving of the motor with a duty control. Therefore, low noise and low pulse pressure can be achieved.

### CROSS REFERENCE TO RELATED APPLICATION

This application is based upon and claims the benefit of Japanese Patent Application No. 2003-2087 filed on Jan. 8, 2003, the content of which are incorporated herein by reference.

### FIELD OF THE INVENTION

The present invention relates to a hydraulic braking apparatus which is preferably used for an anti-lock braking system (hereinafter, referred to as “ABS system”) for a vehicle.

### BACKGROUND OF THE INVENTION

Conventionally, an art is disclosed that, in order to reduce a noise to be generated from a hydraulic pump or a motor for operating the pump, a motor for operating a re-circulation pump of the ABS is driving under duty ratio control to decrease motor rotation speed. However, the motor rotational speed changes because of temperature, an application voltage, a pump load and the like. Especially, the pump load changes whether brake fluid exists in a reservoir for ABS or not. The pump load sharply decreases when the brake fluid for sucking up in the reservoir is completely consumed even if the motor is duty controlled. Accordingly, since the motor rotational speed rapidly increases, the noise is not reduced sufficiently.

To solve above mentioned problem, an art is disclosed in Japanese patent 8-501614 which reduces a noise generated by a hydraulic pump or a motor that drives the hydraulic pump. The art executes a motor current control taking into consideration a temperature change, a supply voltage change, reaction force of hydraulic pressure, a pump load, abrasion and the like.

Another art disclosed in Japanese patent 10-508561 reduces a noise when controlling a re-circulation pump of the ABS by applying current which is just sufficient to return the fluid pressure that has flowed out from the wheel cylinder.

Yet another structure is disclosed in Japanese patent 2670340 in which a master cylinder (hereinafter referred to as M/C) reservoir is communicated with a reservoir for ABS when a pedal is not depressed by the driver. This structure allows detection of leak of the brake fluid from the brake conduit of the ABS or the reservoir based on the fact that the amount of the fluid in the M/C reservoir decreases.

However, in the related art as disclosed in Japanese patent 8-501614, a voltage which is generated when a driving pulse for applying the pump is input to a controller using an analogue circuit to detect the rotational speed of the pump. This makes manufacturing cost of a product increases.

Also, the related art in Japanese patent 10-508561 does not disclose how to determine the amount of current applied to the pump motor which is just sufficient to return the pressure fluid that has flowed out of the wheel cylinder (hereinafter referred to as W/C), that is, a concrete method for detecting the pressure fluid that flowed out and the amount of current that is applied.

Further, the related art disclosed in Japanese patent 2670340 does not aim to reduce the operational noise of the pump. Therefore, a structure for reducing the noise is not disclosed.

### SUMMARY OF THE INVENTION

In consideration of the foregoing points, it is an object of the present invention to provide a hydraulic braking apparatus for obviating above mentioned problems.

It is another object of the present invention to reduce a noise even in a case where noise reduction is difficult even if driving the pump motor under a duty ratio control, by making the amount of the oil which is sucked up by the pump from inside the reservoir to be equal to or greater than a predetermined amount when the pump is operated.

A braking apparatus according to the first aspect of the present invention aims to reduce the operational noise of the pump and the motor, that is, the noise, when the pump sucks up the brake fluid reserved in the reservoir chamber which is provided in the hydraulic braking apparatus, by controlling the duty ratio of the electric power which is applied to the motor for driving the pump. In this braking apparatus, the reservoir is a switching reservoir which prohibits flowing in and out of the brake fluid through the connection port when the amount of the brake fluid reserved in the reservoir chamber is equal to or greater than a predetermined amount since the valve is changed to be in a closed state, while the pump is capable of sucking up the brake fluid which is reserved in the reservoir chamber through the reservoir port. On the other hand, when the amount of the reserved fluid decreased to be smaller than the predetermined amount, the valve is changed to be in an open state and the reservoir permits the brake fluid to flow in and out through the connection port, and thus the pump is capable of sucking up, through the reservoir port, the brake fluid that flowed into the reservoir chamber through the connection port. Accordingly, the brake fluid with the predetermined amount or more which is sufficient to be always sucked in at an intake port of the pump while braking is applied (such as by depression of the brake pedal by the driver). This prevents increase in an operational noise of the pump and the motor due to absence of the fluid to be sucked in at the intake port when the pump sucks up the fluid, leading to a no load state of the pump. Therefore, it is possible to always keep the operational noise of the pump and the motor small whose duty ratio is controlled.

In other words, according to the first aspect of the present invention, at least a predetermined amount of the brake fluid is reserved in the reservoir chamber of the switching reservoir during braking. Accordingly, the pump is capable of sucking up the brake fluid which is reserved through the reservoir port without being changed to be in the no load state in any case.

When the sucking up of the brake fluid causes the amount of the brake fluid to decrease to be smaller than the predetermined amount in the reservoir chamber, the valve of the connection port is changed to be in the open state, which allows the brake fluid to flow in the reservoir through the connection port. Therefore, the amount of the brake fluid does not decrease to zero but increases to the predetermined amount or more. Therefore, even in this case, the load to the intake port of the pump does not become zero, and it is possible to prevent the operational noise of the pump and the motor and keep the operational noise to small.

According to the second aspect of the present invention, a driving apparatus controls the duty ratio in accordance with the voltage which is applied to the motor, such that the duty ratio decreases as the voltage increases.

Therefore, according to the second aspect, even if there is fluctuation in the voltage which is applied to the motor, the duty ratio of the electric power that drives the motor decreases as the voltage increases. Therefore, increase of the rotational speed of the motor is suppressed and the pressure pulsation of the brake fluid discharged from the pump is reduced.

Therefore, according to the third aspect of the present invention, the driving apparatus controls the duty ratio in accordance with the brake fluid pressure that acts on the discharge port of the pump such that the duty ratio increases as the brake fluid pressure increases.

According to the present invention, the duty ratio of the electric power that drives the motor increases, as the brake fluid pressure that acts on the discharge port of the pump increases. Therefore, it is possible to increase the rotational speed of the motor which should normally decrease as the pump load increases in accordance with the brake fluid pressure. Accordingly, it is possible to make the rotational speed of the motor constant, that is, the rotational speed of the pump, independently of the fluctuation of the pump load, and to reduce the pressure pulsation of the brake fluid discharged from the pump.

In other words, normally, the duty ratio decreases as the brake fluid pressure decreases. Corresponding to this relationship, the rotational speed of the pump increases due to the decrease of the pump load as a result of decrease in the brake fluid pressure. This increase of the rotational speed of the pump is suppressed by reducing the duty ratio, thereby making the rotational speed of the pump constant and reducing the pump pulse pressure.

According to the fourth aspect of the present invention, when the brake fluid is sucked up by the pump through the reservoir port and thus the amount of the brake fluid in the reservoir chamber decreased to be smaller than the predetermined amount, the valve is changed to be in the open state. In this state, the brake fluid flows from the M/C through the valve, and the brake fluid is able to be sucked up through the reservoir port. Accordingly, during braking, the pump is capable of sucking up the brake fluid in a state where the predetermined amount of the brake fluid to be sucked up is maintained. Therefore, the fluctuation in the pump load is small, and fluctuation in the rotational speed of the pump, particularly, the high revolution phenomenon when no load is applied does not occur, thereby suppressing the operational noise of the pump.

### BRIEF DESCRIPTION OF THE DRAWINGS

Other objects, features and advantages of the present invention will be understood more fully from the following detailed description made with reference to the accompanying drawings. In the drawings:

FIG. 1 is a system configuration diagram of a hydraulic braking apparatus according to an embodiment of the present invention; and

FIG. 2 is a characteristic diagram of a duty ratio for driving a motor which is set in accordance with the M/C pressure.

### DETAILED DESCRIPTION OF THE PREFERRED EMBODIMENT

The present invention will be described further with reference to various embodiments in the drawings.

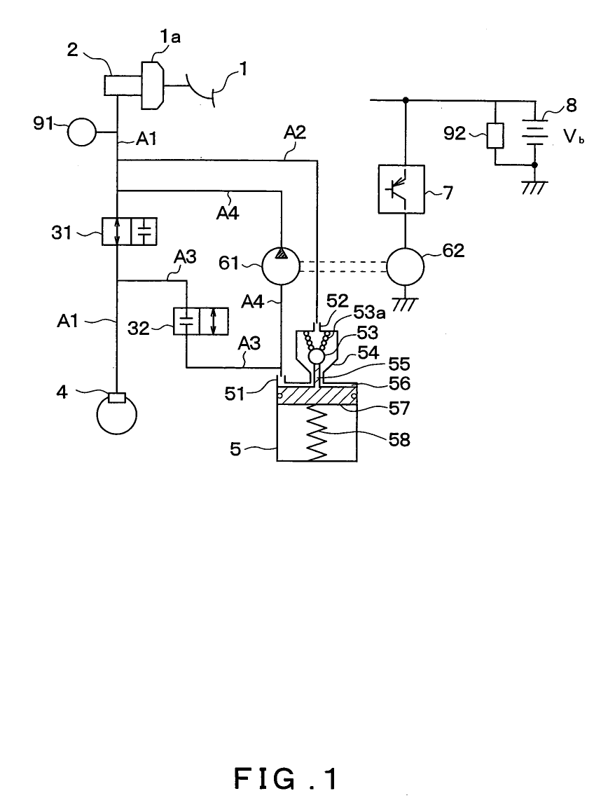

Hereafter, an embodiment of the present invention will be explained. FIG. 1 is a system configuration diagram of a hydraulic braking apparatus according to an embodiment of the present invention. The hydraulic braking apparatus according to the present embodiment is controlled by an ECU for an ABS (which is not shown). FIG. 1 shows a part of one of the two brake circuits of the hydraulic braking apparatus generating a braking force on the four wheels of the vehicle. Note that a portion illustrated in FIG. 1 is part that applies a braking force only to one of the four wheels.

A brake pedal 1 depressed by a driver when applying a braking force to the vehicle is connected to a booster 1a that boosts a brake pedal depression force or the like. Next, the boosted brake pedal depression force is transmitted to an M/C 2 via a push rod or the like.

The M/C 2 includes a fluid chamber therein. In the fluid chamber of the M/C 2, a master cylinder pressure (hereinafter, referred to as M/C pressure) is generated which has a predetermined boost ratio with respect to the brake pedal depression force applied to the brake pedal 1. A first brake conduit A1 is connected to the fluid chamber of the M/C 2. The first brake conduit A1 is communicated with a fluid pressure sensor 91 for detecting a fluid pressure within the first brake conduit A1, that is, the M/C pressure.

A pressure increase control valve 31 is disposed in the first brake conduit A1 that controls increase in the brake fluid pressure which is applied to a W/C 4 for a braking wheel. The pressure increase control valve 31 is a two-positional solenoid valve whose opened state and closed state are able to be controlled by the ECU. When the two-positional solenoid valve is controlled to be in the opened state, the brake fluid pressure can be applied to the W/C 4 based on the M/C pressure or the like.

Note that the pressure increase control valve 31 is controlled to a normally opened state when a normal brake is applied without an ABS control being executed. The first brake conduit A1 is connected to the reservoir port 51 of a switching reservoir 5 at a point between the pressure increase control valve 31 and the W/C 4, via a third brake conduit A3. This apparatus is structured such that the brake fluid is relieved to the switching reservoir 5 via the third brake conduit A3, whereby the brake fluid pressure is controlled in the W/C 4 and it is possible to suppress that the wheel is prone to locked state. Details of the switching reservoir 5 will be described later.

A pressure decrease control valve 32 whose communicated and closed states are able to be controlled by the ECU is disposed in the third brake conduit A3. The pressure decrease control valve 32 is normally disconnected in a normal braking state (that is, when ABS is not operated). The pressure decrease control valve 32 is changed into an opened state as appropriately when the brake fluid is relieved to the switching reservoir 5.

A fourth brake conduit A4 connects the reservoir port 51 of the switching reservoir 5 and a portion of the first conduit A1 disposed between the M/C 2 and the pressure increase control valve 31. A pump 61 is disposed in the fourth brake conduit A4 such that an intake port thereof is connected to the reservoir port 51 and a discharge port thereof is connected to the first brake conduit A1, that is the M/C 2. Therefore, when the M/C pressure increases during braking, the increased amount of the M/C pressure is applied to the discharge port of the pump 61 as a pump load.

Moreover, a second brake conduit A2 is provided between a connection port 52 of the switching reservoir 5 and the M/C 2. The pump 61 is driven by rotation of a motor 62 to suck up the brake fluid via the second brake conduit A2, the switching reservoir 5 and the fourth brake conduit A4, and discharge it to the first brake conduit A1 via the discharge port.

The motor 62 is driven by a driving apparatus 7. The driving apparatus 7 controls the motor 62 with a duty ratio by applying and not-applying a driving voltage and a driving current to be applied to the motor 62. As the duty ratio decreases, rotational speed of the motor 62 decreases, resulting in small suction capability (sucking amount) of the pump 61. On the other hand, as the duty ratio increases (a direct current is applied at the maximum duty ratio of 100%), the suction capability of the pump 61 increases.

In the present embodiment, the driving apparatus 7 sets the duty ratio in accordance with the M/C pressure and a voltage Vb of a battery 8 corresponding to a voltage which is applied to the motor 62.

That is, the driving apparatus 7 responds to the fluctuation of the battery voltage Vb depending on the state of charge of the battery 8 and the state of the battery load or the like, and it sets the duty ratio such that the duty ratio decreases as the battery voltage Vb (i.e., a terminal voltage of the battery 8) detected by the voltage sensor 92. Accordingly, even when the battery voltage Vb increases, the rotational speed of the motor 62 does not excessively increase, and an operational noise of the pump 61 is reduced.

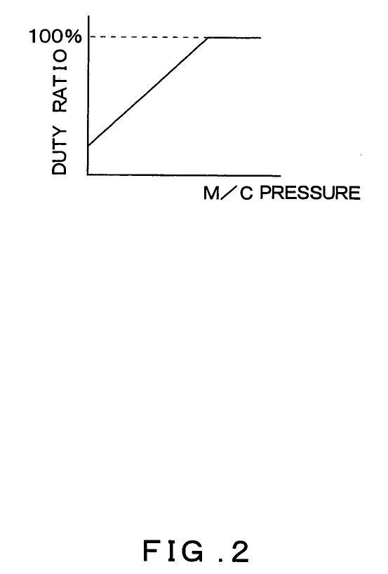

Additionally, in accordance with the M/C pressure detected by the fluid pressure sensor 91, the driving apparatus 7 sets the duty ratio as shown in the characteristic diagram in FIG. 2, such that the duty ratio increases as the M/C pressure increases, or it decreases as the M/C pressure decreases.

The load of the pump 61 increases as the fluid pressure at the discharge port thereof increases. Since the M/C pressure is applied to the discharge port of the pump 61, the pump load decreases as the M/C pressure decreases. This means that, if the duty ratio is constant, the rotational speed of the pump increases.

In the present embodiment, an increase in the rotational speed of the pump 61 is prevented by reducing the drive duty ratio of the motor 62 as the M/C pressure, that is, the pump load decreases. Accordingly, an operational noise of the pump can be suppressed while a necessary suction amount is secured.

Next, a structure of the previously mentioned switching reservoir 5 will be explained. The switching reservoir 5 is disposed between the M/C 2 and the pump 61, and has the connection port 52 that receives the brake fluid that flows in through the second brake conduit A2 in which a pressure equivalent to the M/C pressure is applied. Further, the switching reservoir 5 has a reservoir port 51 which is connected to the third brake conduit A3 and permits the brake fluid which is released during the ABS control to flow in.

A ball valve 53 is disposed at a portion inner than the connection port 52 in the switching reservoir 5. The ball valve 53 is fixed by being pressed by a spring 53a toward a valve seat 54 that constitutes a valve hole.

Further, a rod 55 is provided separately from and below the ball valve 53. The rod 55 slides in the valve hole at a certain stroke length so as to move the ball valve 53 in the vertical direction. Note that the switching valve is constituted by the ball valve 53, the valve seat 54 and the rod 55.

A reservoir chamber 56 is provided with a piston 57 and a spring 58. The piston 57 causes the rod 55 to synchronize with the piston 57, and the spring 58 pressurizes the piston 57 upward so as to generate a force to press out the brake fluid in the reservoir chamber 56.

When the brake fluid flows in the switching reservoir 5 from the reservoir port 51, the piston 57 slides downward and allows the brake fluid to be reserved in the reservoir chamber 56. At this time, in accordance with the downward sliding of the piston 57, the rod 55 also moves downward, causing the ball valve 53 to be seated on the valve seat 54. Accordingly, the intake port side of the pump 61 is disconnected from the second brake conduit A2.

On the contrary, when the brake fluid flows out through the reservoir port 51 sucked by being sucked by the pump 61, the piston 57 slides upward and the rod 55 moves upward accordingly. Due to this movement, the ball valve 53 separates from the valve seat 54 and the switching valve is changed to be in the opened state. Accordingly, the second brake conduit A2 and the intake port side of the pump 61 are communicated.

In other words, when the amount of the brake fluid reserved in the reservoir chamber 56 is less than a predetermined amount, and the piston 57 rises to the vicinity of the uppermost position of the reservoir chamber 56, the rod 55 moves upward accordingly to push the ball valve 53 up. Therefore, an interval between the ball valve 53 and the valve seat 54 is created. In this state, the brake fluid is allowed to flow in the reservoir chamber 56 through the second brake conduit A2 and the connection port 52 from the M/C 2 side. At this time, when the pump 61 is operated, the pump 61 can suck up the brake fluid which has flowed in through the connection port 52, as it is, through the reservoir port 51.

On the other hand, there is a case where the amount of the brake fluid which is reserved in the reservoir chamber 56 becomes equal to or greater than a predetermined amount, due to flow-in of the brake fluid through the connection port 52, flow-in of the brake fluid through the reservoir port 51 as a result of the pressure reduction in the W/C 4 or the like, and the piston 57 moves downward in the reservoir chamber 56 accordingly. In this case, the rod 55 also moves downward and the ball valve 53 is seated on the valve seat 54. A closed state is created in the switching valve, whereby the flow-in of the brake fluid from the second brake conduit A2 and the connection port 52 to the reservoir chamber 56 is prohibited. When the pump 61 is operated in this state, the pump 61 can suck up the brake fluid in the reservoir chamber 56 with the amount equal to or greater than the predetermined amount through the reservoir port 51.

As explained above, in the present embodiment, when the amount of the brake fluid reserved in the reservoir chamber 56 of the switching reservoir 5 during the ABS control reaches zero and decreased to less than a predetermined amount, the switching valve constituted by the ball valve 53, the valve seat 54, and the rod 55 are changed to be in the opened state. Accordingly, the brake fluid flows in the switching reservoir 5 through this switching valve from the M/C 2. Therefore, the pump 61 is in a state where it is always capable of sucking up and pumping up the brake fluid.

Therefore, the load of the pump 61 remains stable rather than decreasing sharply because, for example, the amount of the brake fluid reserved in the reservoir chamber 56 becomes zero. This embodiment can even be applied to a case where the duty ratio of the motor 62 that drives the pump 61 is controlled in order to reduce an operational noise by decreasing the rotational speed of the motor 62. Even in this case, abnormal increase of the rotational speed due to great fluctuation of the pump load can be prevented, and the pump 61 can be always operated at a stable and small rotational speed. Accordingly, the noise caused by operation of the pump 61 and the motor 62 can be suppressed.

Further, since the load of the pump 61 is stable with less fluctuation, the fluctuation of the rotational speed of the pump, that is the pressure pulsation of the brake fluid discharged from the pump also decreases. Therefore, vibration of the brake pedal 1 due to this pulse pressure can be suppressed which is generated by being transmitted through the first brake conduit A1 and the M/C 2, whereby driving comfort of the driver is not deteriorated.

Moreover, according to the present embodiment, when driving the motor 62 that drives the pump 61 with the duty ratio control, the duty ratio is set such that the duty ratio decreases as the battery voltage Vb applied to the motor 62 increases or the M/C pressure corresponding to the pump load decreases. Therefore, an increase in the rotational speed of the motor 62 is reduced, and the motor 62 and the pump 61 can be operated at a stable rotational speed with less fluctuation. Accordingly, noise and the pressure pulsation of the brake fluid discharged from the pump 61 can be suppressed.

While the above description is of the preferred embodiments of the present invention, it should be appreciated that the invention may be modified, altered, or varied without deviating from the scope and fair meaning of the following claims.

What is claimed is:

1. A hydraulic braking apparatus which generates a braking force to a wheel using a brake fluid pressure, which comprises:
a switching reservoir provided with a reservoir chamber which reserves the brake fluid, a reservoir port through which the brake fluid flows in and out of the reservoir chamber, and a connection port with a valve which is opened when the amount of the brake fluid which is reserved in the reservoir chamber is less than a predetermined amount and is closed when the amount of the brake fluid which is reserved in the reservoir chamber is equal to or greater than the predetermined amount and through which the brake fluid flows in and out of the reservoir chamber when the valve is in an open state;
a pump which has an intake port of which is connected to the reservoir port of the switching reservoir;
a motor which drives the pump; and
a driving apparatus that controls a duty ratio of the motor.

2. A hydraulic braking apparatus comprising:
a master cylinder which generates a master cylinder pressure by a braking operation performed by a driver;
a wheel cylinder which generates a braking force to a wheel;
a first brake conduit that connects the master cylinder and the wheel cylinder;
a pressure increase control valve which is disposed between the master cylinder and the wheel cylinder in the first brake conduit and communicates or disconnects the first brake conduit;
a switching reservoir provided with a reservoir chamber which reserves the brake fluid, a reservoir port through which the brake fluid flows in and out of the reservoir chamber, and a connection port, which is connected between the master cylinder and the increase control valve via a second brake conduit with a valve which is opened when the amount of the brake fluid which is reserved in the reservoir chamber is less than a predetermined amount and is closed when the amount of the brake fluid which is reserved in the reservoir chamber is equal to or greater than the predetermined amount and through which the brake fluid flows in and out of the reservoir chamber when the valve is in an open state;
a pressure decrease control valve which communicates and disconnects a third brake conduit that connects the wheel cylinder and the reservoir port;
a pump that sucks up the reserved brake fluid from the reservoir port, and discharges the brake fluid to the first brake conduit between the master cylinder and the pressure increase control valve;
a motor which drives the pump; and
a driving apparatus that controls a duty ratio of the motor.

3. The hydraulic braking apparatus according to claim 1, wherein the driving apparatus controls the duty ratio, in accordance with a voltage which is applied to the motor, such that the duty ratio decreases as the voltage increases.

4. The hydraulic braking apparatus according to claim 2, wherein the driving apparatus controls the duty ratio, in accordance with a voltage which is applied to the motor, such that the duty ratio decreases as the voltage increases.

5. The hydraulic braking apparatus according to claim 1, wherein the driving apparatus controls the duty ratio, in accordance with a brake fluid pressure which acts on a discharge port of the pump, such that the duty ratio increases as the brake fluid pressure increases.

6. The hydraulic braking apparatus according to claim 2, wherein the driving apparatus controls the duty ratio, in accordance with a brake fluid pressure which acts on a discharge port of the pump, such that the duty ratio increases as the brake fluid pressure increases.

7. The hydraulic braking apparatus according to claim 2, wherein the driving apparatus controls the duty ratio, in accordance with a fluid pressure of the master cylinder which acts on a discharge port of the pump, the duty ratio decreases as the fluid pressure of the master cylinder decreases.

8. The hydraulic braking apparatus according to claim 7, wherein when the brake fluid is sucked up by the pump through the reservoir port and the amount of the brake fluid in the reservoir chamber decreases to less than the predetermined amount, the valve is changed to be in an open state, the brake fluid flows in the reservoir chamber from the master cylinder through the valve and the brake fluid that has flowed in is sucked up by the pump through the reservoir port.
